(19) United States
(12) Patent Application Publication
(10) Pub. No.: US 2014/0175219 A1
(43) Pub. Date: Jun. 26, 2014

(54) FIXED AIRCRAFT AISLE PARTITION WITH LIGHTING

(71) Applicant: C&D Zodiac, Inc., Huntington Beach, CA (US)

(72) Inventors: William Wai-Loong Young, Long Beach, CA (US); Glen A. Noda, Irvine, CA (US); Ian Geoffrey Scoley, Huntington Beach, CA (US); Nicholas Lee, Huntington Beach, CA (US)

(73) Assignee: C&D Zodiac, Inc., Huntington Beach, CA (US)

(21) Appl. No.: 14/102,480

(22) Filed: Dec. 10, 2013

Related U.S. Application Data
(60) Provisional application No. 61/735,955, filed on Dec. 11, 2012.

(51) Int. Cl. B64D 11/00; B64D 11/04; B64D 11/02

(52) U.S. Cl. CPC B64D 11/0023; B64D 11/02; B64D 11/04
USPC 244/118.5

(57) ABSTRACT

A partition configured to be positioned within an aircraft. The partition includes a first divider wall having a first wall portion and a first divider assembly. The first divider assembly includes a first lighted member and first lighting for illuminating the first lighted member. The partition also includes a second divider wall that is spaced apart from the first divider wall. The second divider wall includes a second wall portion and a second divider assembly that includes a second lighted member and second lighting for illuminating the second lighted member.

### CROSS REFERENCE TO RELATED APPLICATIONS

This application claims the benefit of U.S. Provisional Application No. 61/735,955, filed Dec. 11, 2012, which is herein incorporated by reference in its entirety.

### FIELD OF THE INVENTION

The present invention relates generally to a partition for an aircraft, and more particularly to a fixed partition that includes lighting.

### BACKGROUND OF THE INVENTION

Aircraft typically include curtains or the like for separating different sections or cabin, e.g., economy, business and first class sections) from one another. However, with increased security measures in recent times, curtains can be a complete block to site lines down the aircraft. Furthermore, curtains are susceptible to odor and spills. Accordingly, a need exists for partitions that can indicate the separation between different sections or cabins of an aircraft, without completely blocking site lines.

### SUMMARY OF THE PREFERRED EMBODIMENTS

In accordance with a first aspect of the present invention, there is provided a partition configured to be positioned within an aircraft. The partition includes a first divider wall having a first wall portion and a first divider assembly. The first divider assembly includes a first lighted member and first lighting for illuminating the first lighted member. The partition also includes a second divider wall that is spaced apart from the first divider wall. The second divider wall includes a second wall portion and a second divider assembly that includes a second lighted member and second lighting for illuminating the second lighted. member. In a preferred embodiment, the first divider assembly includes a first frame member that is attached to the first wall portion and secures the first lighted member in position, and the second divider assembly includes a second frame member that is attached to the second wall portion and secures the second lighted member in position. Preferably, the first lighted member includes top, bottom, inboard and outboard surfaces, and the first lighting is housed in the first frame member and adjacent the outboard surface of the first lighted member. Preferably, the second lighted member includes top, bottom, inboard and outboard surfaces, and the second lighting is housed in the second frame member and adjacent the outboard surface of the second lighted member.

In a preferred embodiment, the first divider wall has a top and a bottom and the first divider assembly is positioned at or near the top of the first divider wall, the second divider wall has a top and a bottom and the second divider assembly is positioned at or near the top of the second divider wall. Preferably, the first frame member houses the bottom and outboard surfaces of the first lighted member, and the second frame member houses the bottom and outboard surfaces of the second lighted member. In a preferred embodiment, the first and second lighting comprise first and second LED light strips, respectively and the first LED light strip is positioned adjacent a first lens, and the second LED light strip is positioned adjacent a second lens. Preferably, the first divider assembly includes a first trim member attached to the top and inboard surfaces of the first lighted member, and the second divider assembly includes a second trim member attached to the top and inboard surfaces of the first lighted member. In a preferred embodiment, the first divider wall extends outwardly from a first monument, and the second divider wall extends outwardly from a second monument. The first and second monuments are both one of a lavatory monument, a galley monument or a marketplace monument

In accordance with another aspect of the present invention there is provided an aircraft that includes an interior that is divided into at least first and second class sections, and a partition that is positioned between the first class section and the second class section. The partition includes a first divider wall ha a first wall portion and a first divider assembly. The first divider assembly includes a first lighted member and first lighting for illuminating the first lighted member. The partition also includes a second divider wall that is spaced apart from the first divider wall. The second divider wall includes a second wall portion and a second divider assembly that includes a second lighted member and second lighting for illuminating the second lighted member. At least a portion of the aisle is defined between the first and second divider walls.

In a preferred embodiment, the present invention provides a semi-transparent barrier or partition between sections of a passenger aircraft. In use, the partition can be employed to discourage passengers from moving from one cabin to another during flight, for example to sightsee or to use the front lavatory; to protect the last row of the front cabin customers from disturbances around the lavatory and marketplace; and to create an enticing entrance to the cabin that emphasizes the airline's master brand; and does not intrude on the marketplace function and core experience.

The divider assemblies of the present invention provide a translucent but present barrier between two distinct areas (e.g., cabins). Additional lighting effects highlight the area and offer a “gateway” entrance to different areas of the cabin. The present invention provides additional visibility throughout the cabin (over curtains), and a striking aesthetic feature to modernize the look of the cabin.

### BRIEF DESCRIPTION OF THE DRAWINGS

FIG. 1 is a perspective view of a partition positioned between two cabins in an aircraft in accordance with a preferred embodiment of the present invention;

FIG. 2 is a plan view of the partition of FIG. 1 extending from exemplary marketplace and lavatory monuments;

FIG. 3 is a perspective view of a divider assembly from the partition of FIG 1;

FIG. 4 is an exploded perspective view of the divider assembly of FIG. 3;

FIG. 5 is a cross-sectional view taken along line 5-5 of FIG. 3

FIG. 6 is a perspective view of a marketplace monument that includes a divider wall extending therefrom;

FIG. 7 is a perspective view of a divider assembly in accordance with another preferred embodiment of the present invention; and

FIG. 8 is a cross-sectional view taken along line 8-8 of FIG. 7.

Like numerals refer to like parts throughout the several views of the drawings.

### DETAILED DESCRIPTION OF TILE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “'bottom,” “side,” “short,” “long,” “up,” “down,” “aft,” “forward,” “inboard,” “outboard” and “below” used. herein are merely for ease of description and refer to the orientation of the components as show the figures. It should be understood that any orientation of the components described herein is within the scope of the present invention.

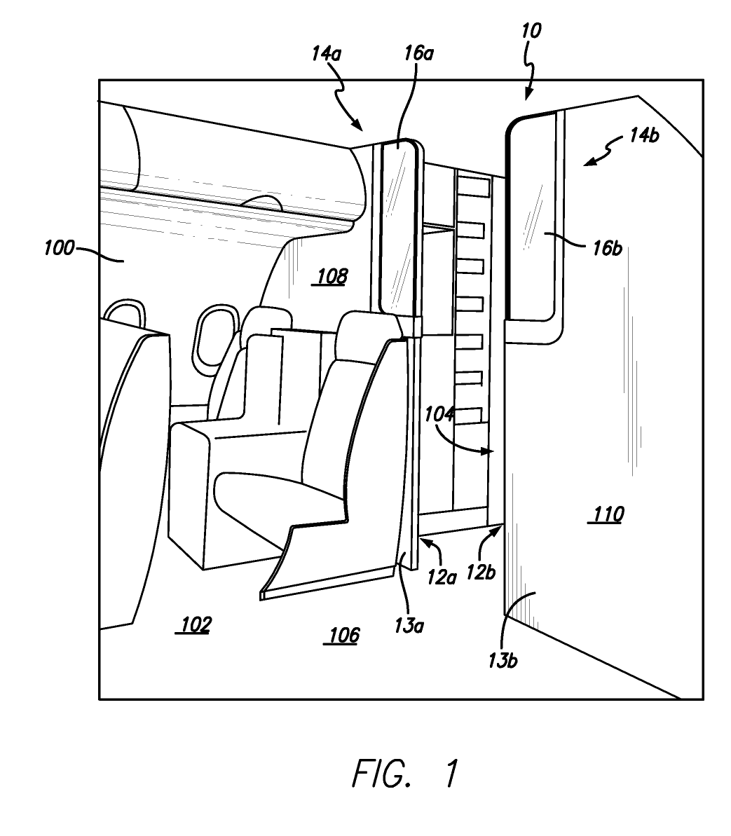

Referring now to the drawings, which a for the purpose of illustrating the present invention and not for purposes of limiting the same, FIGS. 1-8 show embodiments of a partition 10. In particular, the invention can be used on commercial passenger aircraft. However, this is not a limitation on the present invention and the partition can be used elsewhere. Furthermore, the drawings show the partition 10 positioned in the mid cabin of an aircraft 100 between a business class 102 and economy class 104. However, this is not a limitation on the present invention and the partition 10 can be positioned elsewhere.

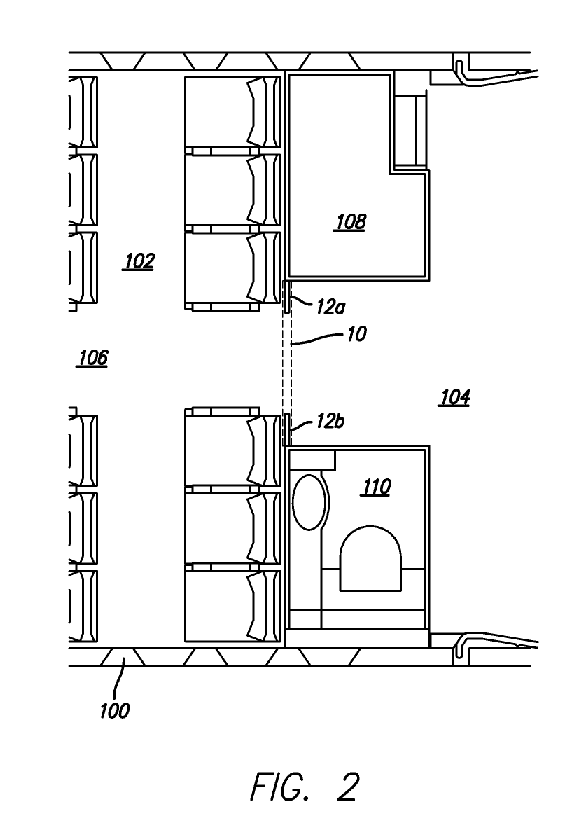

As shown in FIGS. 1-2, in a preferred embodiment, the partition 10 includes at least one (and preferably first and second) walls 12a and 12b that extend at least partially into and at least partially define the aisle 106. It will be appreciated that the components of the first divider wall 12a are generally denoted herein with an “a” and components of the second divider wall 12b are generally denoted with a “b”. However, because the components are generally mirror images of one another in some portions of the specification and drawings, the “a” and “b” are omitted. As shown in FIG. 1, partition 10 preferably includes first and second walls 12a and 12b that extend from a marketplace monument 108 and a lavatory monument 110. However, this is not a limitation on the present invention and the first and second divider walls 12a and 12b can extend from any type of monument (e.g., galley, closet, etc.) or the side wall or other portion of the aircraft interior. As shown in FIG. 1, in a preferred embodiment, first and second divider walls 12a and 12b include first and second wall portions 13a and 13b and first and second divider assemblies 14a and 14b, respectively.

As shown in FIG. 2, in a preferred embodiment, the divider walls 12a and 12b do not extend into the aisle 106 far enough to reduce the width of the aisle 106. In an exemplary embodiment, the first and second divider walls 12a and 12b include a 20″ space therebetween.

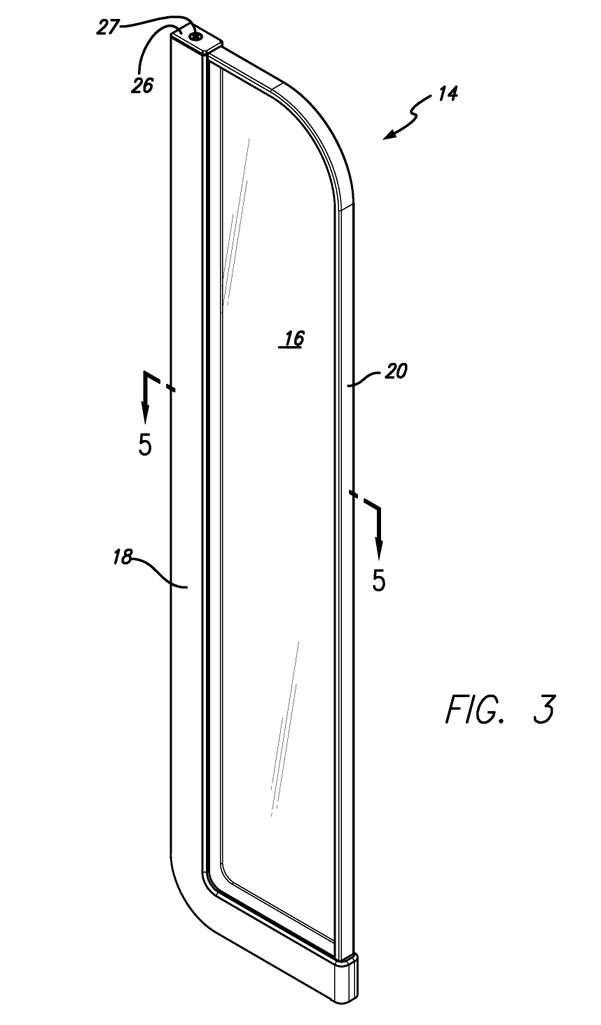

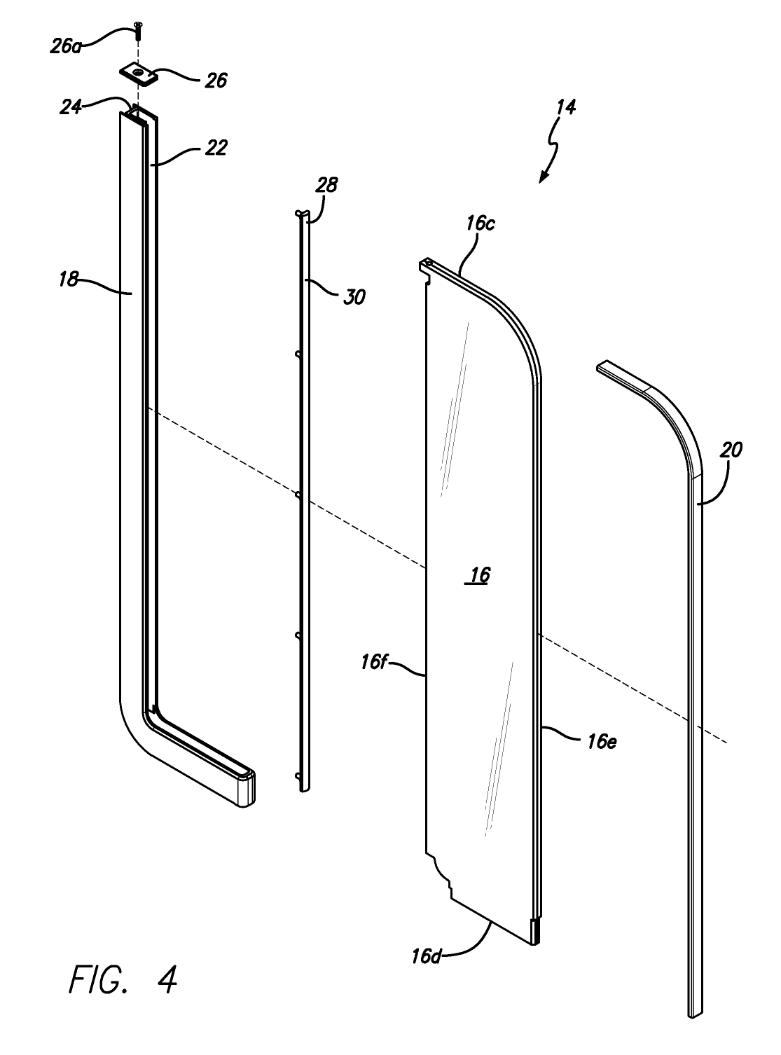

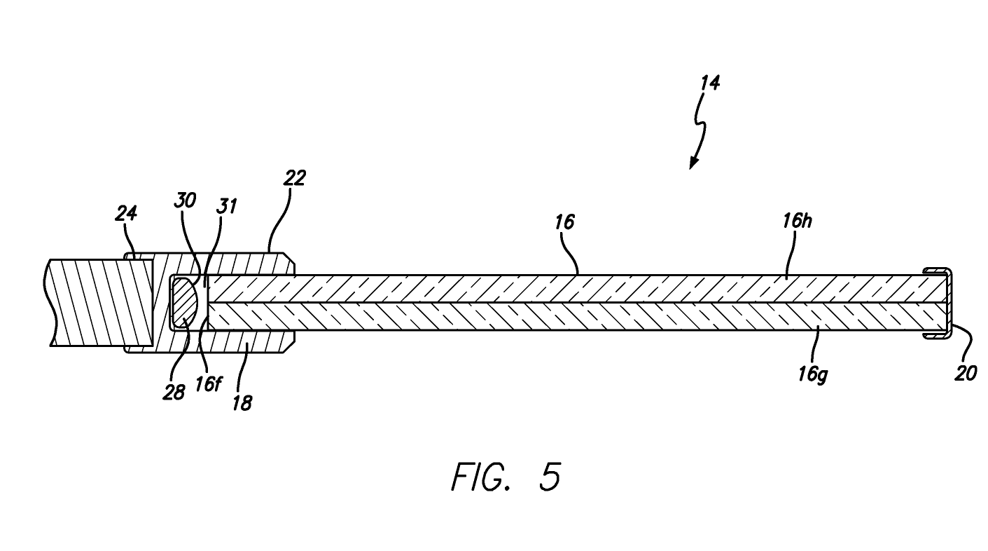

FIGS. 3-5 show a divider assembly 14 in further detail. In a preferred embodiment, the divider assembly 14 includes a lighted member 16 and a frame member 18 that extends at least partially around the lighted member 16. The lighted member 16 includes a top surface 16c, bottom surface 16d, inboard surface 16e and outboard surface 16f. As shown in FIGS. 4-5, in a preferred embodiment, the frame member 18 extends around the outboard surface 16f and the bottom surface 16d of the lighted member 16. In a preferred embodiment, the frame 18 is comprised of an opaque material (e.g., aluminum, or a certified plastic).

The frame member 18 is secured to wall portion 13a or 13b by any known method. For example, the frame member can be attached by adhesive or mechanical fasteners to the honeycomb core panel of the wall members 13a or 13b. In another embodiment, the frame member 18 can extend all the way around the lighted member 16. In a preferred embodiment, the divider assembly 14 also includes a trim member 20 that extends around the top surface 16c and the inboard surface 16e of the lighted member 16. However, this is not a limitation on the present invention and can be omitted. The trim member 20 can be attached to the lighted member 16 by glue, threaded fasteners or other attachment means. In another embodiment, the trim member 20 can be connected to the frame member 18. In an embodiment, the frame member 18 and trim member 20 can be the same size and configuration (i.e., one frame that extends all the way around the lighted member 16. The frame member 18 and trim member 20 can also include a transparent insert that sandwiches the lighted member 16 or mesh into the frame member 18.

The frame member 18 includes a lighted member recess 22 and a wall recess 24 for receiving a portion of the wall of a monument. Preferably, the bracket member 20 also includes a cap 26 for helping secure the lighted member 16 within the lighted member recess 22. The cap member 26 can include one or more threaded fasteners 27 or the like to secure the cap member 26 in place.

In a preferred embodiment, the divider assembly 14 includes lighting for illuminating the lighted member 16. As shown in FIG. 4, in a preferred embodiment, the lighting is a LED light strip 28 that includes or is positioned adjacent to a lens 30. However, this is not a limitation and any type of lighting is within the scope of the present invention. The LED light strip 28 is positioned within the light member recess 22 and adjacent the outboard surface 16f of the lighted member 16. As shown in FIG. 5, in a preferred embodiment, a light space 31 is defined between the outboard surface 16f of the lighted member 16 and the inner surface of the frame member 18. It will be appreciated that in use, the lighting provides illumination to the lighted member for an aesthetic effect and to provide a demarcation between the cabins.

Preferably, the lighted member 16 is made of a translucent or transparent material (e.g., PVC, acrylic/PVC alloyed thermoplastic or the like) so that the light emitted from the LED light strip 28 shines therethrough and is dispersed throughout. Any translucent or transparent material is within the scope of the invention. Furthermore, a mesh (as described below) can also be used. Also, a protective coating can be applied to the lighted member 26 to prevent chipping or scratching. As shown in FIGS. 4-5, in a preferred embodiment, the lighted member 16 includes two pieces 16g and 16h. In another embodiment, the lighted member 16 can be a single piece or include more than two pieces. In another embodiment, the lighted member 16 can include lighting embedded therein. In another embodiment, lighting can be provided adjacent one or more of the top, bottom and inboard edges of the hated member 16. The lighted member 16 can also include indicia thereon. For example, the airline brand can be etched therein.

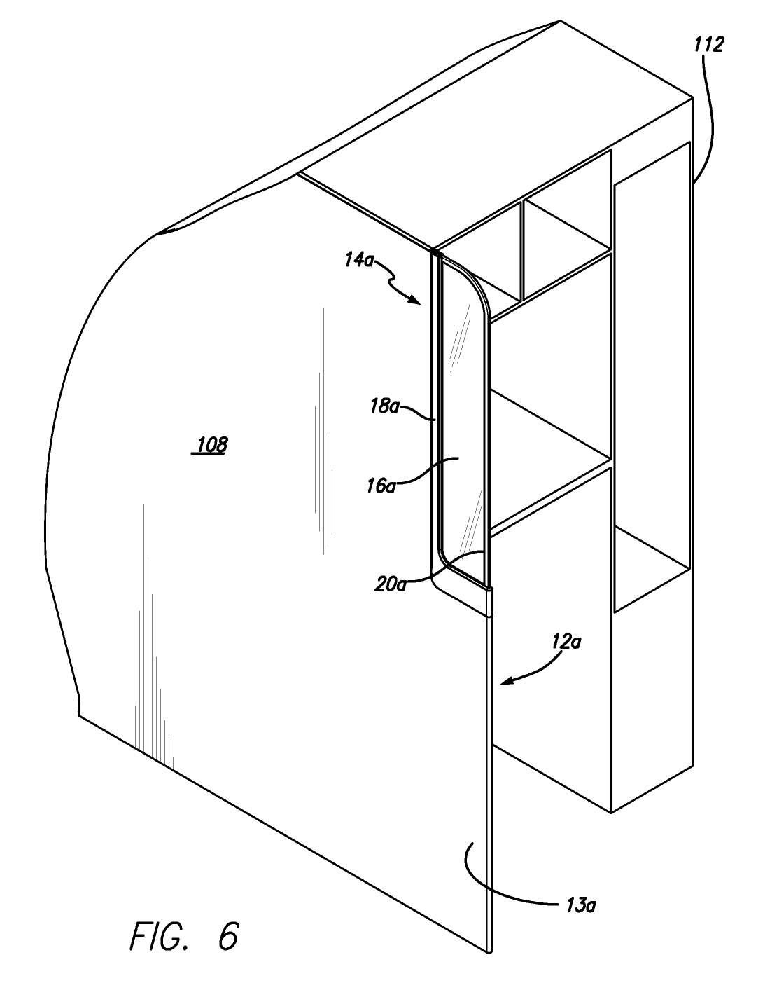

FIG. 6 shows first divider wall 12a as part of a marketplace monument 108. When part of a monument, the divider wall 12a (or 12b) typically extends further into the aisle that the wall 112 on the opposite side of the monument 108.

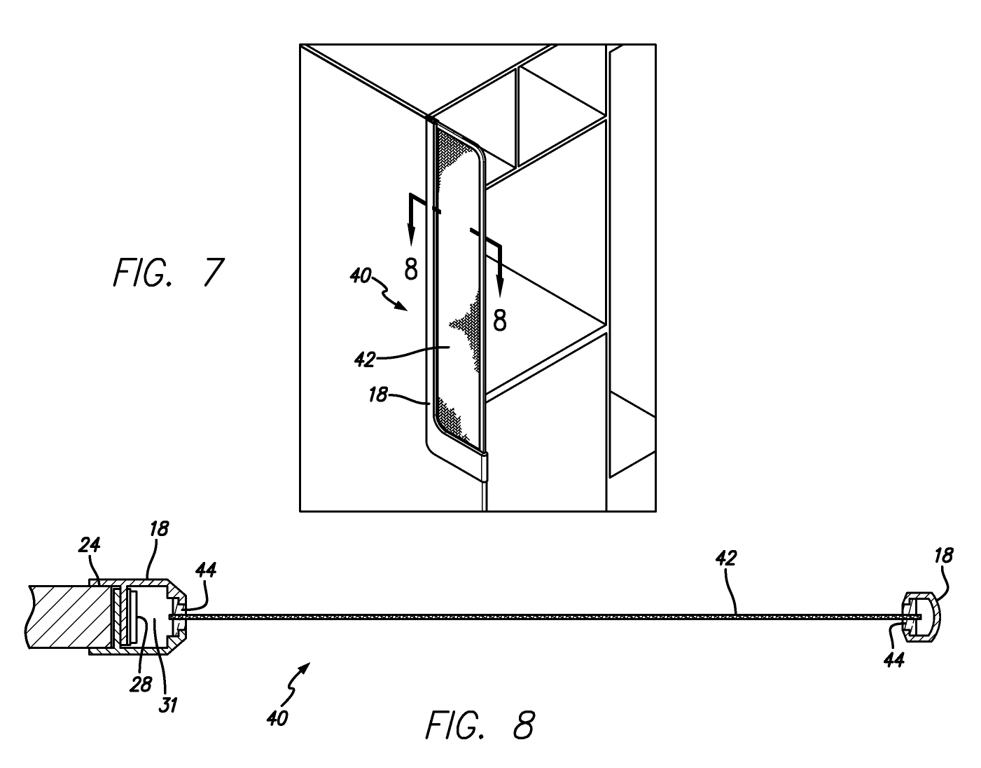

FIGS. 7-8 show another embodiment of a divider member 40 that includes a mesh lighted member 42. In this embodiment, the frame member 18 extends all the way around and clamps the mesh lighted member 42 within the space defined therein to hold it in tension. In a preferred embodiment, the frame member 18 includes a transparent or translucent portion 44 through which the LED light strip 28 shines light. As shown in FIG. 8, the LED light strip 28 is positioned adjacent the mesh lighted member 42. And, as a result of the thickness of the mesh lighted member 42, the light washes over the mesh thereby lighting it and providing a demarcation between cabins.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges. Further, any specific materials noted herein are only examples: alternative implementations may employ differing materials.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention a been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A partition configured to be positioned within an aircraft, the partition comprising:
a first divider wall that includes a first wall portion and a first divider assembly, wherein the first divider assembly includes a first lighted member and first lighting for illuminating the first lighted member, and
a second divider wall that is spaced apart from the first divider wall, wherein the second divider wall includes a second wall portion and a second divider assembly, wherein the second divider assembly includes a second lighted member and second lighting for illuminating the second lighted member.

2. The partition of claim 1 wherein the first divider assembly includes a first frame member that is attached to the first wall portion and secures the first lighted member in position, and wherein the second divider assembly includes a second frame member that is attached to the second wall portion and secures the second lighted member in position.

3. The partition of claim 2 wherein the first lighted member includes top, bottom, inboard and outboard surfaces, wherein the first lighting is housed in the first frame member and adjacent the outboard surface of the first lighted member, wherein the second lighted member includes top, bottom, inboard and outboard surfaces, and wherein the second lighting is housed in the second frame member and adjacent the outboard surface of the second lighted member.

4. The partition of claim 3 wherein the first divider wall has a top and a bottom and. wherein the first divider assembly is positioned at or near the top of the first divider wall, wherein the second divider wall has a top and a bottom and wherein the second divider assembly is positioned at or Bear the top of the second divider wall.

5. The partition of claim 4 wherein the first frame member houses the bottom and outboard surfaces of the first lighted member, and wherein the second frame member houses the bottom and outboard surfaces of the second lighted member.

6. The partition of claim 5 wherein the first and second lighting comprise first and second LED light strips, respectively.

7. The partition of claim 6 wherein the first LED light strip is positioned adjacent a first lens, and wherein the second LED light strip is positioned adjacent a second lens.

8. The partition of claim 7 wherein the first divider assembly further comprises a first trim member attached to the top and inboard surfaces of the first lighted member, and wherein the second divider assembly further comprises a second trim member attached to the top and inboard surfaces of the first lighted member.

9. The partition of claim 1 wherein the first divider wall extends outwardly from a first monument, and wherein the second divider wall extends outwardly from a second monument.

10. The partition of claim 9 wherein the first monument is one of a lavatory monument, a galley monument or a marketplace monument, and wherein the second monument is one of a lavatory monument, a galley monument or a marketplace monument.

11. An aircraft comprising:
an interior that is divided into at least first and second class sections, and
a partition that is positioned between the first class section and the second class section, wherein the partition includes
a first divider wall that includes a first wall portion and a first divider assembly, wherein the first divider assembly includes a first lighted member and first lighting for illuminating the first lighted member, and.
a second divider wall that is spaced apart from the first divider wall, wherein the second divider wall includes a second wall portion and a second divider assembly, wherein the second divider assembly includes a second lighted member and second lighting for illuminating the second lighted member,
wherein at least a portion of the aisle is defined between the first and second divider walls.

12. The aircraft of claim 11 wherein the first divider assembly includes a first frame member that is attached to the first wall portion and secures the first lighted member in position, and wherein the second divider assembly includes a second frame member that is attached to the second wall portion and secures the second lighted member in position.

13. The aircraft of claim 12 wherein the first lighted member includes top, bottom, inboard and outboard surfaces, wherein the first lighting is housed in the first frame member and adjacent the outboard surface of the first lighted member, wherein the second lighted member includes top, bottom, inboard and outboard surfaces, and wherein the second lighting is housed in the second frame member and adjacent the outboard surface of the second hated member.

14. The aircraft of claim 13 wherein the first lighting comprises a first LED light strip that is positioned adjacent a first lens, and wherein the second lighting comprises a second LED light strip that is positioned adjacent a second lens.

15. The aircraft of claim 11 wherein the first divider wall extends outwardly from a first monument, and wherein the second divider wall extends outwardly from a second monument.

16. The aircraft of claim 15 wherein the first monument is one of a lavatory monument, a galley monument or a marketplace monument, and wherein the second monument is one of a lavatory monument, a galley monument or a marketplace monument.
